(19) United States
(12) Patent Application Publication
(10) Pub. No.: US 2008/0047248 A1
(43) Pub. Date: Feb. 28, 2008

(54) AGRICULTURAL CARRIER VEHICLE

(76) Inventors: Andreas Haffert, Guetersloh (DE); Ludger Frerichs, Sassenberg (DE); Hubert Erdmann, Bielefeld (DE)

Correspondence Address: Michael J. Striker, 103 East Neck Road, Huntington, NY, 11743, US

(21) Appl. No.: 11/845,309

(22) Filed: Aug. 27, 2007

(30) Foreign Application Priority Data
Aug. 28, 2006 (DE) 10 2006 040 106.9

(51) Int. Cl. A01B 73/00

(52) U.S. Cl. 56/228

(57) ABSTRACT

An agricultural carrier vehicle has a feeder housing and a front harvesting attachment capable of being swiveled from a working position into a hauling position, for picking up and conveying crop material. The feeder housing and the front harvesting attachment are interconnected via at least one adapting device, which is designed such that, when the front harvesting attachment is swiveled from a working position into a hauling position, the connection between the front harvesting attachment and the feeder housing is maintained, and, during the hauling operation, the carrier vehicle draws the front harvesting attachment using the adapting device in a direction of travel for hauling.

### CROSS-REFERENCE TO A RELATED APPLICATION

The invention described and claimed hereinbelow is also described in German Patent Application DE 10 2006 040 106.9 filed on Aug. 28, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a self-propelled agricultural carrier vehicle, in particular a forage harvester, with a front harvesting attachment capable of being swiveled from a working position into a hauling position.

Carrier vehicles such as self-propelled harvesting machines are equipped with detachable, front harvesting attachments for harvesting and drawing in crop material. Since the size of areas to be worked continues these harvesting machines are equipped with front harvesting attachments that are becoming increasingly wider and heavier. In contrast to combine harvesters, which typically include rigid headers and are loaded onto trailers for hauling, forage harvesters are equipped with foldable, front harvesting attachments, which are folded up using various mechanisms for hauling on the road, and which typically remain on the front part of the forage harvester.

With the known forage harvesters, the limits of the axle loads permitted by law are being reached. In particular, the conventional design of a forage harvester results in a displacement of the center of gravity toward the front region, which impairs drivability at high speeds in particular. To avoid disadvantages such as these, fixed jockey wheels or separate support trailers were assigned to the front harvesting attachments—the designs of which are becoming increasingly wide—in order to reduce the load on the front wheels of the forage harvester during working operation or during operation on the road. In addition, the foldable, front harvesting attachments, which are pushed along in front of the harvesting machine while it is driven on the road, are usually folded vertically upward, so they are located no more than 3 meters in front—as viewed in the direction of travel—of the steering wheel of the harvesting machine, as is required by law.

In publication DE 19918551 its provided that an additional wheel is assigned to the front harvesting attachment in order to support it; the additional wheel may be lowered to the ground when the harvesting machine is driven on the road. The front-end load on the harvesting machine is thereby relieved, and the legal regulations regarding axle loads may be complied with. In an exemplary embodiment, the additional wheel is located on a separate trailer, which may be slid underneath the front harvesting attachment and secured there. The trailer is mounted on a transmission housing underneath the header auger and direct-cut attachment, which extends from a lower frame of the front harvesting attachment toward the front; accordingly, the support forces are also introduced into the transmission housing.

The disadvantage of this design is that, unless a transmission housing of this type is reinforced—which is a costly procedure—it is not dimensioned to absorb strong forces of the type that occur when the vehicle is driven along an uneven road in particular. A further disadvantage results from the fact that, in order to ensure that the front harvesting attachments are located no more than 3 meters in front—as viewed in the direction of travel—of the steering wheel of the harvesting machine, the front harvesting attachments—the width of which is continually increasing—must be folded vertically upward, because they must be pushed along in front of the harvesting machine while it is driven on the road. This limits the field of view of the driver of the harvesting machine considerably while he drives the harvesting machine on the road. In addition, laborious retrofitting work must be carried out to move the front harvesting attachment from a working-operation position into a hauling-operation position.

Publication DE 10 2004 059 038 A1 makes known a combination of a harvesting machine, a front harvesting attachment, and a trailer for supporting the front harvesting machine. The trailer includes a frame and at least one wheel, which extends downward from the frame, thereby serving to relieve weight from the front wheels of the self-propelled harvesting machine while it is driven on the road. The harvesting machine pushes the trailer along in front as it is driven on the road. It is also disadvantageous that the front harvesting attachment must be folded vertically upward in this case in order to keep it within 3 meters in front—as viewed in the direction of travel—of the steering wheel of the harvesting machine, as is required by law. With front harvesting attachments with working widths greater than 10 meters, this also results in a considerable restriction of the field of view of the driver while driving on the road, and could result in the front harvesting attachment swaying when traveling along uneven portions of a road, thereby making the harvesting machine difficult to maneuver. Finally, the driver of the harvesting machine must climb out of the harvesting machine in order to move the front harvesting attachment into the road-operation position by sliding the support trailer into place. The driver of the harvesting machine must perform laborious retrofitting work in this case as well.

### SUMMARY OF THE INVENTION

The object of the present invention, therefore, is to avoid the disadvantages of the related art described above and, in particular, to make it possible to comply with the legal requirements in terms of the distribution of the axle load and keeping the front harvesting attachment within 3 meters from the front—as viewed in the direction of travel—of the steering wheel of the carrier vehicle during road operation of agricultural carrier vehicles with front harvesting attachments—which are heavy and have extensive working widths—without the driver needing to climb out of the driver's cab to perform retrofitting work on the front harvesting attachment, and without having to put up with a limited field of view during the hauling operation.

In keeping with these objects and with others which will become apparent hereinafter, one feature of the present invention resides, briefly stated, in an agricultural carrier vehicle, comprising a feeder housing; a front harvesting attachment swivelable from a working position into a hauling position for picking up and conveying crop material; at least one adapting device interconnecting said feeder housing and said front harvesting attachment, said at least one adapting device being configured such that when said front harvesting attachment is swiveled from the working position into the hauling position, a connection between said front harvesting attachment and said feeder housing is maintained, and during a hauling operation the carrier vehicle draws said front harvesting attachment using said adapting device in a direction of travel for hauling.

Given that at least one adapting device is designed to maintain a connection of the front harvesting attachment with the feeder housing when the front harvesting attachment is swiveled from a working-operation position into a hauling-operation position, and given that the harvesting machine draws the front harvesting attachment using this adapting device during the hauling operation, it is advantageously ensured that it is no longer necessary to perform retrofitting work or remove the front harvesting attachment in order to switch from the working operation to the hauling operation, and it is always possible to remain within the 3-meter distance in front—as viewed in the direction of travel—of the steering wheel, even when using front harvesting attachments with very large working widths.

In an advantageous embodiment of the present invention, the at least one adapting device is located above the intake opening of the feeder housing, thereby allowing the open space there to be utilized.

Given that the front harvesting attachment is capable of being swiveled around a vertical axis and a horizontal axis simultaneously using the adapting device, it is possible to safely haul the front harvesting attachment with the agricultural carrier vehicle even when driving around curves and over uneven terrain. The adapting device is preferably designed as a fifth wheel coupling for this purpose. The fifth wheel coupling is connected via a horizontally supported joint device with a frame connected with the front harvesting attachment, thereby ensuring that extraordinarily great maneuverability may be attained during the hauling operation.

Given that an adjusting device capable of being swiveled vertically out of its working position by nearly 900 relative to the feeder housing is assigned to the front harvesting attachment, the ability to swivel the front harvesting attachment from its working-operation position into its hauling-operation position may be attained in a technically simple manner.

In a particularly simple manner, the adjusting device is composed of piston cylinders, which are mounted via their ends on the intake housing and the frame. The adjusting device is released from the frame during the hauling operation, so that the adjustment may be carried out from the driver's cab and operation is not impaired.

In a particularly advantageous embodiment of the present invention, the front harvesting attachment is composed of a base part and side parts mounted thereon in a pivotable manner. The base part is preferably located essentially in the center and in a manner such that it extends across the entire width of the agricultural harvesting machine, thereby ensuring that a substantial portion of the working width may be covered using a single-piece frame design, and that the coupling of the drive of the agricultural carrier vehicle together with the front harvesting attachment—which includes a base part of this type—may be more easily accomplished. It is therefore possible to attach the front harvesting attachment to the carrier vehicle in a manner that is that much more stable and safeguarded against overturning. In addition, it remains possible to remain within the legally prescribed hauling width.

Given that the base part is hinge-mounted on the carrier vehicle such that it is pivotable in the vertical direction around a pivot axis that is nearly horizontal and oriented transversely to the carrier vehicle, and that the side parts may be swiveled together into a position pointing in the longitudinal direction of the carrier vehicle during the swivel motion, it is ensured that the entire front harvesting attachment assumes a hauling-operation position in which weight is distributed evenly, and that it may be hauled reliably by the agricultural carrier vehicle. The side parts are preferably located in front of and at least partially underneath the base part when in the hauling position, thereby ensuring that the legally prescribed hauling width is not exceeded.

In an advantageous refinement of the present invention, the swivel planes of the base part and/or the side parts are oriented vertically upward when in the hauling position, thereby eliminating the need to install protective devices such as side panels or other cover devices to protect the front harvesting attachment and saving the driver a great deal of effort to install protective devices of this type.

Given that at least one jockey wheel, which is capable of moving freely in the manner of a pendulum along a vertical axis of rotation and which is in contact with the ground during the hauling operation, is assigned to the front harvesting attachment, the front harvesting attachment is supported in a technically simple manner and may be drawn by the agricultural carrier vehicle. In addition, weight is relieved from the wheels of the agricultural harvesting machine, so that the maximum permissible axle loads may always be attained when driving on a public road, even with front harvesting attachments with large working widths.

In, a preferred embodiment, at least two jockey wheels are used; they are mounted on the side parts, thereby ensuring that the jockey wheels are supported even when the front harvesting attachment is swiveled from a working-operation position into a hauling-operation position.

Given that a driver's cab is assigned to the agricultural harvesting machine, which is movable from at least one working-operation position and into a hauling-operation position, and vice versa, it is ensured that the agricultural carrier vehicle may be operated in two directions of travel and that the driver has a clear field of view toward the front, in the particular direction of travel. The position is preferably changed by displacing and/or swiveling the driver's cab. The driver's cab may be connected with the agricultural carrier vehicle in any position.

In a further embodiment of the present invention, the driver's cab is located nearly in the center between the axle units when in the hauling-operation position, thereby reducing the vibrations that act on the driver during the hauling travel and imparting a pleasant driving sensation to the driver.

To evenly distribute the loads on the axles of the agricultural carrier vehicle, the front harvesting attachment is located in the region of the first axle unit, and the at least one drive unit is located in the region of the further axle unit. This design advantageously results in greater driving comfort. The drive unit is preferably composed of a motor, a transmission, and a radiator.

The upper discharge chute is advantageously supported on the drawn, front harvest attachment during hauling to ensure that very long upper discharge chutes, in particular, are designed such that they need not be designed such that a great detail of technical effort is required to fold or retract them, as is required to comply with legal requirements in terms of width when hauled in street traffic.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a side view of the agricultural carrier vehicle designed as a forage harvester, with a partial sectional view of the functional assemblies, in accordance with the present invention.

FIG. 2 shows a schematic top view of the agricultural carrier vehicle designed as a forage harvester with the front harvest attachment unfolded in the working-operation position, in accordance with the present invention.

### DESCRIPTION OF THE PREFERRED EMBODIMENTS

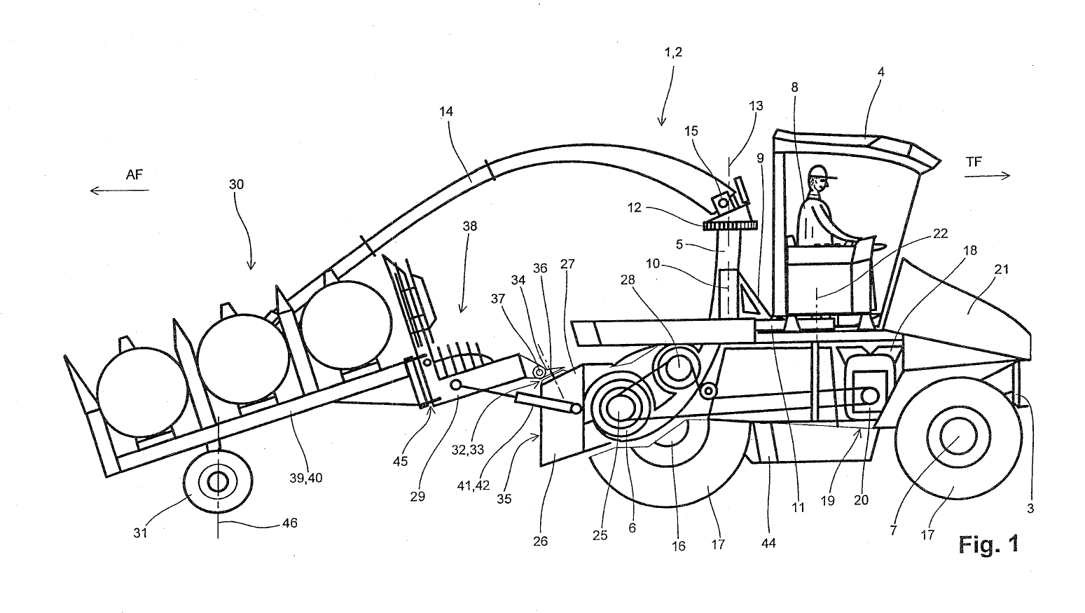

Agricultural carrier vehicle 2 configured as a self-propelled combine harvester 1 and shown in FIG. 1 includes a ground drive 3, on which a driver's cab 4 is located. Next to driver's cab 4, the upper end of a rising upper discharge chute 5 is located on ground drive 3. Upper discharge chute 5 extends from a chopper drum 6 inside ground drive 3 to above ground drive 3.

When in a road-operation position or a hauling-operation position, driver's cab 4 is located nearly in the center between a first axle unit 7 and upper discharge chute 5. Driver 8 is looking in the direction toward first axle unit 7. Driver's cab 4 is mounted on a swivel device 9, which is capable of being swiveled horizontally around a vertical axis of rotation 10. Swivel device 9 is designed as a straight swivel arm 11, on the outer end of which driver's cab 4 is supported such that it is rotatable around vertical axis of rotation 10. Axis of rotation 10 and swivel device 9 are located in front of upper discharge chute 5, so that, when the driver's cab is swiveled 180° around upper discharge chute 5, neither driver's cab 4 nor swivel device 9 come in contact with upper discharge chute 5, nor do they come within a safety margin. Driver's cab 4 is supported on the outer end of swivel arm 11 such that it is rotatable around vertical axis 22. This makes it possible for driver's cab 4 to encircle upper discharge chute 5 completely, in a partially rotatory and partially translatory manner.

An upper discharge chute 14, which is capable of being rotated around a vertical axis of rotation 13 via a flange joint 12 and which is also height-adjustable around a horizontal axis 15, is flange-connected on lower discharge chute 5. It is feasible that two driver's cabs 4 are assigned to carrier vehicle 2.

During working operation, carrier vehicle 2 is preferably driven in a working direction of travel AF, although carrier vehicle 2 may also drive backwards, in the opposite direction, for shunting.

Ground drive 3 of carrier vehicle 2 is carried by first axle unit 7 and a further axle unit 16. First axle unit 7 includes wheels 17 with a smaller circumference than those on further axle unit 16. A drive unit 19 designed as an internal combustion engine 18, a transmission 20, and a cooling system 21 are located in the region of first axle unit 7. The largest portion of the load of drive unit 19 rests on first axle unit 7. The center of gravity of drive unit 19 overall is located approximately at the level of first axle unit 7, due to the situation of engine 18 and transmission 20. It is feasible that at least two drive units 19, preferably internal combustion engines 18, are assigned to carrier vehicle 2, in order to provide even greater power reserves for the working operation.

A functional assembly 25, which includes a feeder housing 26 and an intake chute 27 inserted therein, is assigned to further axle unit 16. Not-shown intake and compression rollers are located in lower discharge chute 5, which extends nearly vertically and is located downstream of intake chute 27. Located downstream of intake and compression rollers are a chopper drum 6, a not-shown corn cracker, and a post-accelerator 28, which are driven via a drive unit 19.

It is within the scope of the present invention that further working devices are assigned to lower discharge chute 5.

A multi-piece, front harvesting attachment 30 that includes a frame 29 and has a large working width is assigned to intake chute 27. As in the exemplary embodiment shown, front harvesting attachments 30 are typically equipped with highly diverse types of folding mechanisms, to allow them to typically remain within the region of feeder housing 26 of carrier vehicle 2 during operation on the road. It is also known to assign fixed jockey wheels 31 or separate support trailers to front harvesting attachments 30—the designs of which are becoming increasingly wide—in order to reduce the load on wheels 17 of further axle unit 16 of carrier vehicle 2 during the working operation or during operation on the road. In addition, foldable, front harvesting attachments 30, which are pushed along in front of carrier vehicle 2 when hauled on the road, are usually folded vertically upward, so they are located no more than 3 meters in front—as viewed in the direction of travel—of the steering wheel of carrier vehicle 2, as is required by law.

With front harvesting attachments 30 with working widths greater than 10 meters, this also results in a considerable restriction of the field of view of driver 8 while driving on the road, and could result in front harvesting attachment 30 swaying when traveling along uneven portions of a road, thereby making carrier vehicle 2 difficult to maneuver. In addition, driver 8 of carrier vehicle 2 must also perform somewhat laborious retrofitting work to bring front harvesting attachment 30 from a working-operation position into a hauling-operation position.

According to the present invention, at least one adapting device 33 designed as a fifth wheel coupling 32 known per se and which connects front harvesting attachment 30 and feeder housing 26 is therefore assigned to carrier vehicle 2. Adapting device 33 is connected via a horizontally supported joint device 34 with a frame 29 connected with front harvesting attachment 30. When front harvesting attachment 30 is swiveled from a working-operation position into a hauling-operation position, adapting device 33 maintains the connection of front harvesting attachment 30 with feeder housing 26. During hauling operation, carrier vehicle 2 draws front harvesting attachment 30 using adapting device 33 in a hauling direction of travel TF.

Given that carrier vehicle 2 no longer needs to push front harvesting attachment 30 in front of it during the hauling operation, it is no longer necessary to perform retrofitting work or to remove front harvesting attachment 30 to switch from the working operation to the hauling operation, and it is possible to always remain in compliance with the legal limits on axle load and the maximum limit of a 3-meter distance in front of the steering wheel, as viewed in the direction of travel, even when hauling front harvesting attachments 30 with very large working widths. The design of a fifth wheel coupling 32 is disclosed in publication DE 3826612 A1, the disclosure of which is hereby referred to directly and is therefore part of the disclosure of the present invention. To advantageously use the available free space, adapting device 33 is installed above intake opening 35, and preferably in the middle on top of feeder housing 26. It is within the scope of the present invention for adapting device 33 to be formed by coupling devices similar to the fifth wheel coupling.

To ensure secure hauling when driving around curves and across uneven terrain, front harvesting attachment 30 is capable of being swiveled around a vertical axis and a horizontal axis simultaneously using adapting device 33, thereby ensuring that extraordinarily great maneuverability may be attained during the hauling operation.

Front harvesting attachment 30 shown in FIG. 1 is composed of a base part 38 and side parts 39, 40, which are mounted thereon in a pivotable manner via pivot points 45. To attain the hauling position shown, base part 38 is hinge-mounted such that it is pivotable in the vertical direction around a pivot axis 37, which is nearly horizontal and oriented transversely to the carrier vehicle, and side parts 39, 40 are swiveled together into a position pointing in hauling direction of travel TF during the swivel motion. Base part 38 is located essentially in the center in the front and in a manner such that it extends across the entire width of carrier vehicle 2, thereby ensuring that a substantial portion of the working width may be covered using a single-piece frame design, and that the coupling of the not-shown drive of agricultural carrier vehicle 2 together with front harvesting attachment 30—which includes a base part 38 of this type—can be more easily accomplished. In the hauling end position shown, side parts 39, 40 are located in front of and at least partially underneath base part 38, thereby ensuring that a hauling position can be attained that is that much more stable and safeguarded against overturning. In addition, it remains possible to stay within the legally prescribed hauling width.

An adjusting device 42 designed as piston cylinder 41 and hinge-mounted with frame 29 is mounted on both sides of feeder housing 26 in order to attain the swivel motion of front harvesting attachment 30 by nearly 90° from its working position in the vertical direction. It is feasible to release adjusting device 42 from frame 29 during hauling, to attain the best possible maneuverability of the front harvesting attachment. Furthermore, swivel planes 43 of base part 38 and/or side parts 39, 40 are oriented vertically upward when in the hauling position, thereby eliminating the need to install protective devices such as side panels or other cover devices to protect front harvesting attachment 30, and saving driver 8 a great deal of effort to install protective devices of this type. It is also feasible to design front harvesting attachment 30 as a single piece, two pieces, or more than three pieces.

Furthermore, at least one jockey wheel 31, which is capable of moving freely in the manner of a pendulum along a vertical axis of rotation 46 and which is in contact with the ground during the hauling operation, is assigned to front harvesting attachment 30, so that front harvesting attachment 30 is supported in a technically simple manner during the hauling operation and may be drawn by the agricultural carrier vehicle. In addition, weight is relieved from wheels 17 of the agricultural carrier vehicle, so that the maximum permissible axle loads can always be attained when driving on a public road, even with front harvesting attachments (30) with large working widths.

In a preferred embodiment, which is not shown here, at least two jockey wheels 31 are used; they are mounted on side parts 39, 40, thereby ensuring that jockey wheels 31 support front harvesting attachment 30 when it is swiveled from a working-operation position into a hauling-operation position. The at least two jockey wheels 31 may be integrated in a ground-surface adaptation device, which may be provided, but which is not provided in this case.

According to the present invention, upper discharge chute 14 is supported in the hauling position by front harvesting attachment 30 using a not-shown support device, thereby ensuring that very long upper discharge chutes 14, in particular, need not be designed such that a great detail of technical effort is required to fold or retract them.

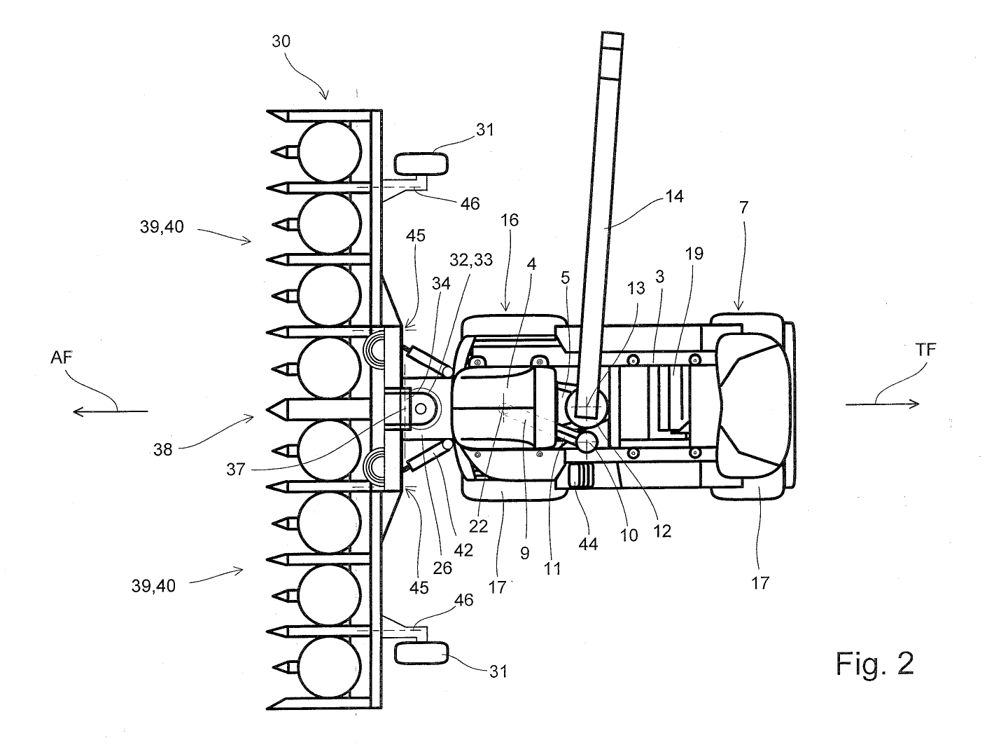

FIG. 2 shows a schematic top view of agricultural carrier vehicle 2 designed as forage harvester 1, with front harvesting attachment 30—which has a large working width—unfolded. In a working-operation position, driver's cab 4 is located above further axle unit 16, and driver's 8 view is directed at front harvesting attachment 30 connected with feeder housing 26 as he steers during the working operation. According to the present invention, at least one adapting device 33 designed as a detachable fifth wheel coupling 32 known per se and which connects front harvesting attachment 30 and feeder housing 26 is assigned to carrier vehicle 2; adapting device 33 is connected via a horizontally supported joint device 34 with a frame 29 connected with front harvesting attachment 30, when front harvesting attachment 30 is swiveled from a working-operation position into a hauling-operation position, it maintains the connection of front harvesting attachment 30 with feeder housing 26.

In the exemplary embodiment shown, front harvesting attachment 30 is located in a working-operation position. Front harvesting attachment 30 extends laterally across the width of agricultural carrier vehicle 2. The center of gravity of front attachment 30—which is unfolded and extends parallel to axle unit 7, 16—is located in the region in front of further axle unit 16 outside of ground drive 3 of carrier vehicle 2. For support, a jockey wheel 31 is assigned to front harvesting attachment 30 close to each lateral end, thereby ensuring that a portion of the weight of front harvesting attachment 30 may be introduced into the ground during the entire working operation. As a result, a great deal of weight is relieved from further axle unit 16. Jockey wheels 31 can be integrated in a ground-surface adaptation device, which may be provided, but which is not shown here. Via front harvesting attachment 30, which cuts the crops in the field and conveys the crop material to intake chute 27, the crop material is directed to downstream functional assembly 25 for further processing, and it exits via lower discharge chute 5.

Abutting upper discharge chute 14 directs the material in the desired direction for transfer to not-shown hauling vehicles. In the working-operation position, agricultural carrier vehicle 2 is operated in a working direction of travel AF and pushes front harvesting attachment 30 along in front, although carrier vehicle 2 can also be driven backwards, in the opposite direction, for shunting. When driver's cab 4 and upper discharge chute 14 change position, from a hauling-operation position into a working-operation position and vice versa, driver's cab 4 and upper discharge chute 14 are moved in the same direction around lower discharge chute 5. Driver's cab 4 may be reached using stairs 44 located near axle unit 16 of carrier vehicle 2.

Even though the present invention was described with reference to only one exemplary embodiment, one skilled in the technical art will deduce—in light of the above description—many diverse alternatives, modifications, and variants that fall within the scope of the present invention. In addition, the present invention is not intended exclusively for use with forage harvester 1. Other types of self-propelled carrier vehicles 2, such as combine harvesters, tractors, system vehicles, etc., can be equipped with an adapting device 33 of this type, in order to draw other front attachments 30 during the hauling operation.

It will be understood that each of the elements described above, or two or more together, may also find a useful application in other types of constructions differing from the type described above.

While the invention has been illustrated and described as embodied in an agricultural carrier vehicle, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An agricultural carrier vehicle, comprising a feeder housing; a front harvesting attachment swivelable from a working position into a hauling position for picking up and conveying crop material; at least one adapting device interconnecting said feeder housing and said front harvesting attachment, said at least one adapting device being configured such that when said front harvesting attachment is swiveled from the working position into the hauling position, a connection between said front harvesting attachment and said feeder housing is maintained, and during a hauling operation the carrier vehicle draws said front harvesting attachment using said adapting device in a direction of travel for hauling.

2. An agricultural carrier vehicle as defined in claim 1, wherein said feeder housing has an intake opening, said at least one adapting device being located above said intake opening.

3. An agricultural carrier vehicle as defined in claim 1, wherein said adapting device is configured so that said front harvesting attachment is swivelable about a vertical axis and a horizontal axis simultaneously via said adapting device.

4. An agricultural carrier vehicle as defined in claim 1, wherein said adapting device is configured as a fifth wheel coupling connected via a horizontally supported joint device with a frame, which is connected with said front harvesting attachment.

5. An agricultural carrier vehicle as defined in claim 1, further comprising an adjusting device swivelable vertically out of its working position by substantially 90° relative to said feeder housing and assigned to said front harvesting attachment.

6. An agricultural carrier vehicle as defined in claim 5, wherein said adjusting device is configurd as piston cylinders having ends attached to said feeder housing and a frame, said adjusting device being releasable from said frame during the hauling operation.

7. An agricultural carrier vehicle as defined in claim 1, wherein said front harvesting attachment is composed of a base part and side parts pivotally attached to said base part.

8. An agricultural carrier vehicle as defined in claim 7, wherein said base part of said front harvesting attachment is located substantially in a center in front of the agricultural carrier vehicle.

9. An agricultural carrier vehicle as defined in claim 7, wherein said base part of said front harvesting attachment extends substantially across an entire width of the agricultural carrier vehicle when in the hauling position.

10. An agricultural carrier vehicle as defined in claim 7, wherein said base part is hinge-mounted on the carrier vehicle such that said base part is pivotable in a vertical direction about a pivot axis which is substantially horizontal and oriented transversely to said carrier vehicle, and said side parts are swiveled together into a position pointing a longitudinal direction of the carrier vehicle during a swivel motion.

11. An agricultural carrier vehicle as defined in claim 7, wherein said side parts of said front harvesting attachment are located in the hauling position in front of said base part and at least partially underneath said base part.

12. An agricultural carrier vehicle as defined in claim 7, wherein at least one part selected from the group consisting of said base part, said side parts, and both has a pivoting plane oriented vertically upwards in the hauling position.

13. An agricultural carrier vehicle as defined in claim 1, further comprising at least one jockey wheel which is movable freely as a pendulum around a vertical axis of rotation and assigned to said front harvesting attachment.

14. An agricultural carrier vehicle as defined in claim 1, wherein said front harvesting attachment has a base part and side parts pivotally connected with said base part, further comprising at least two jockey wheels connected with said front harvesting attachment and each located on each of said side parts.

15. An agricultural carrier vehicle as defined in claim 1, further comprising a driver's cab movable at least from a working-operation position into a hauling-operation position, and vice versa.

16. An agricultural carrier vehicle as defined in claim 15, wherein said driver's cab is configured so that a change in its position takes place by a movement of said driver's cab selected from the group consisting of a swiveling movement, a displacing movement, and both.

17. An agricultural carrier vehicle as defined in claim 15, further comprising axial units axle, said driver's cabin being located substantially in a center between said axle units when in the haul-operation position.

18. An agricultural carrier vehicle as defined in claim 1, further comprising at least one driver unit, and at least two axle units, said front harvesting attachment being located substantially in a region of one of said axle units, while said at least one drive unit is located in a region of another of said axle units.

19. An agricultural carrier vehicle as defined in claim 1, further comprising an upper discharge chute supported on said front harvesting attachment when in a hauling-operation position.

20. An agricultural carrier vehicle as defined in claim 1, wherein the carrier vehicle is configured as a carrier vehicle selected from the group consisting of a combine harvester, a forage harvester, a system vehicle, and a tractor.
